(19) United States
(12) Patent Application Publication
(10) Pub. No.: US 2015/0091502 A1
(43) Pub. Date: Apr. 2, 2015

(54) SHARED ANTENNA SOLUTION FOR WIRELESS CHARGING AND NEAR FIELD COMMUNICATION

(71) Applicant: Texas Instruments Incorporated, Dallas, TX (US)

(72) Inventors: Subhashish Mukherjee, Bangalore (IN); Yogesh Darwhekar, Bangalore (IN); Gireesh Rajendran, Bangalore (IN)

(73) Assignee: Texas Instruments Incorporated, Dallas, TX (US)

(21) Appl. No.: 14/043,516

(22) Filed: Oct. 1, 2013

(51) Int. Cl. H02J 7/02; H01Q 7/00; H04B 5/00

(52) U.S. Cl. CPC H02J 7/025; H04B 5/0087; H04B 5/0037; H01Q 7/00
USPC 320/108; 343/867; 29/601

(57) ABSTRACT

A method of coupling a first port of a single antenna to a first coupling circuit and a second port of the single antenna to a second coupling circuit. The method includes coupling a wireless charging unit to the first coupling unit and coupling an NFC transceiver block to the second coupling circuit. The method further includes isolating the single antenna from the wireless charging unit during a time interval when the NFC transceiver block is operational and isolating the single antenna from the NFC transceiver block during a time interval when the wireless charging unit is operational.

### TECHNICAL FIELD

Embodiments of the disclosure relate to communication antennas and more particularly to antenna solution for wireless charging and near field communication in wireless devices.

### BACKGROUND

Cellular communication systems continue to grow in popularity and have become an integral part of both personal and business communications. As the functionality of cellular communications devices such as mobile devices, smartphones, PDA's etc. continues to increase, so does the demand for smaller devices that are easier and more convenient for users to carry. Nevertheless, the move towards multi-functional devices makes miniaturization more difficult as the requisite number of installed components increases. Indeed, a typical cellular communication device includes several antennas, for example, a Near field communication antenna, a Wi-Fi antenna, a global positioning antenna, and a wireless charging antenna. Near field communication (NFC) is an emerging technology for short range wireless communication operating at 13.56 MHz. The size of the antenna used in NFC devices is large since an NFC device work on the principle of inductive coupling in which voltage/current is generated in one coil due to a change in voltage/current in another coil. For a typical NFC device, the antenna size is approximately 30 mm*50 mm. Wireless charging is based on the principle of magnetic induction to transfer the power for charging. Wireless charging works at frequencies as low as 120 KHz. Thus, the size of the antenna required for wireless charging is considerably large.

Designing a single antenna for NFC and wireless charging would give a huge advantage to the cellular communication device manufacturers. However, there are inherent problems in designing such an antenna. Firstly, NFC requires the antenna to be impedance matched to the cellular device. An antenna used for wireless charging of cellular device has high inductance which makes it difficult to do impedance matching and use it for NFC. Secondly, the voltage limits for wireless charging may be much higher than the voltage tolerance limits of the NFC device. This can damage the NFC device during the wireless charging operation. In addition, NFC devices tend to load the charging coil during wireless charging operation which results in loss of efficiency.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

An embodiment provides an antenna arrangement. The antenna arrangement includes an outer antenna structure in a form of a flat coil having N1 number of turns and an inner antenna structure in a form of a flat coil having N2 number of turns. N1 and N2 are integers. The outer antenna structure and the inner antenna structure are separated by a distance D.

Another example embodiment provides a computing device. The computing device includes a wireless charging unit coupled to an antenna arrangement and a NFC transceiver block coupled to the antenna arrangement. The antenna arrangement includes an outer antenna structure and an inner antenna structure. The inner antenna structure is coplanar with the outer antenna structure and placed within the outer antenna structure. The outer antenna structure and the inner antenna structure are separated by a distance D to reduce an effective inductance offered to the NFC transceiver block.

Another embodiment provides a method of coupling a first port of a single antenna to a first coupling circuit and a second port of the single antenna to a second coupling circuit. A wireless charging unit is coupled to the first coupling unit and an NFC transceiver block is coupled to the second coupling circuit. The single antenna is isolated from the wireless charging unit during a time interval when the NFC transceiver block is operational and the single antenna is isolated from the NFC transceiver block during a time interval when the wireless charging unit is operational.

Other aspects and example embodiments are provided in the Drawings and the Detailed Description that follows.

### BRIEF DESCRIPTION OF THE VIEWS OF DRAWINGS

FIG. 1 illustrates a circuitry that enables the use of a single antenna both for near field communication (NFC) and wireless charging, according to an embodiment;

FIG. 2 illustrates a schematic of the inductance offered to the circuitry illustrated in FIG. 1, according to an embodiment;

FIG. 3 illustrates a computing device using a single antenna both for near field communication (NFC) and wireless charging, according to an embodiment.

### DETAILED DESCRIPTION OF THE EMBODIMENTS

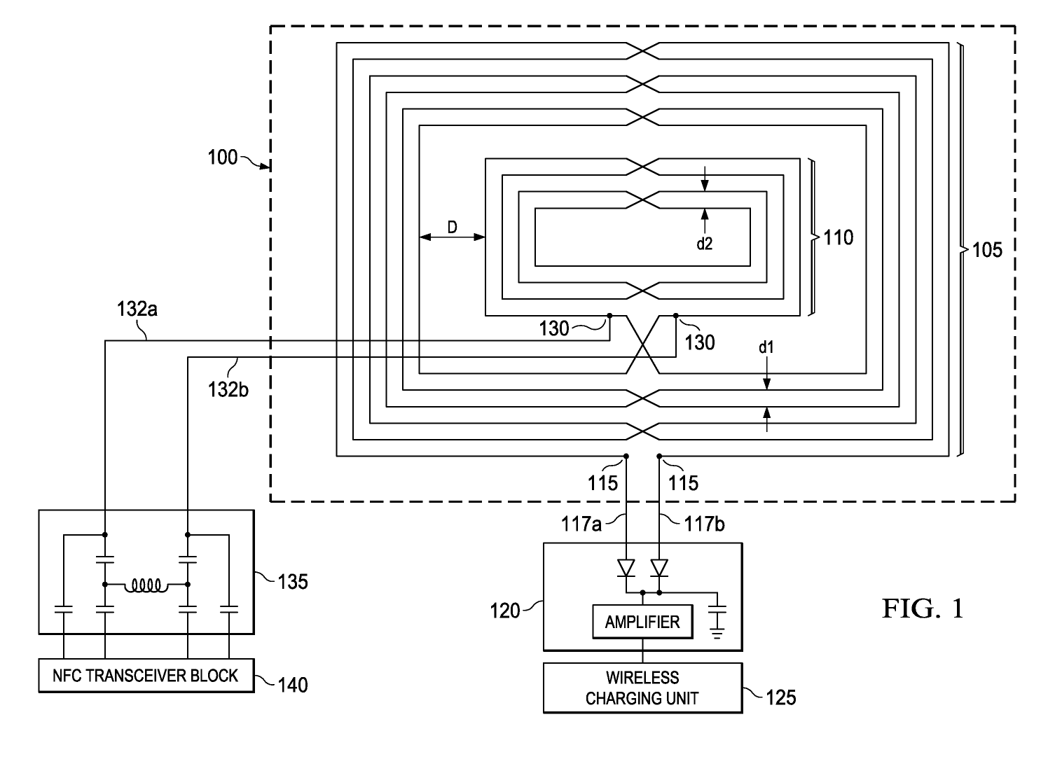

FIG. 1 illustrates a circuitry that enables the use of a single antenna both for near field communication (NFC) and wireless charging, according to an embodiment. The antenna arrangement 100 includes an outer antenna structure 105 and an inner antenna structure 110. The outer antenna structure 105 is in a form of a flat coil and has N1 number of turns, where N1 is an integer. The N1 turns in the outer antenna structure 105 are separated from each other by a distance d1. The inner antenna structure 110 is in a form of a flat coil and has N2 number of turns, where N2 is an integer. The N2 turns in the inner antenna structure 110 are separated from each other by a distance d2. The outer antenna structure 105 and the inner antenna structure 110 are coplanar and the inner antenna structure 110 is placed within the outer antenna structure 105. The outer antenna structure 105 and the inner antenna structure 110 are separated by a distance D. The outer antenna structure 105 and the inner antenna structure 110 are rectangular in shape as shown in FIG. 1. However, in one embodiment, the outer antenna structure 105 and the inner antenna structure 110 can be of any geometric shape, which can be one of the following, but not limited to triangle, square, circle, polygon etc. In one embodiment, the outer antenna structure 105 and the inner antenna structure 110 are irregular in shape. The distance D is greater than d1 and d2. In one embodiment, the distance D is independent of d1 and d2. The outer antenna structure 105 and the inner antenna structure 110 are separated by distance D to reduce the mutual coupling between the N1 turns in outer antenna structure 105 and N2 turns in inner antenna structure 110. A first port 115 of the antenna arrangement 100 is coupled to the first coupling circuit 120 through a differential path 117a and 117b. In one embodiment, the signal paths connected to antenna arrangement 100 are designed as single-ended signal paths. The first coupling circuit 120 is coupled to the wireless charging unit 125. A second port 130 of the antenna arrangement 100 is coupled to the second coupling circuit 135 through a differential path 132a and 132b. The second coupling circuit 135 is coupled to a NFC transceiver block 140. In one embodiment, the second coupling circuit 135 is coupled to an RFID (radio frequency identification) transceiver block. The antenna arrangement 100 is compatible both with NFC tags and RFID tags.

The operation of the antenna arrangement 100 illustrated in FIG. 1 is now explained. The circuitry works in wireless charging mode and communication mode. In wireless charging mode, the antenna arrangement 100 is used for charging the wireless charging unit 125. The outer antenna structure 105 and the inner antenna structure 110 combined are used for charging the wireless charging unit 125. The second coupling circuit 135 acts as an open circuit during wireless charging mode and thus the NFC transceiver block 140 is not exposed to high voltage swing used for charging wireless charging unit 125. Thus, the wireless charging unit 125 is isolated from the NFC transceiver block 140 during a time interval when the wireless charging unit is operational. Wireless energy transmission techniques are based on inductive coupling between a transmit antenna embedded, for example, in a “charging” mat and a receive antenna (antenna 100) to be charged. A radiant field is received by antenna 100 and the energy is coupled to the first coupling circuit 120 through the first port 115. In one embodiment, the first coupling circuit includes a rectifier, a capacitor and an amplifier. The rectifier generates a DC signal from received signal and the capacitor temporarily stores the generated signal. The amplifier amplifies the stored signal. The amplified signal is stored in the wireless charging unit 125. In communication mode, the antenna arrangement 100 isolates the wireless charging unit 125 from the NFC transceiver block 140 during a time interval when the NFC transceiver block 140 is operational. The inner antenna structure 110 with N2 number of turns is used for NFC communication. The NFC signals in differential form are received or transmitted on the second port 130 and provided to NFC transceiver block 140 through the differential path 132a and 132b. In one embodiment, the antenna arrangement 100 supports simultaneous functioning of both wireless charging mode and communication mode.

The antenna arrangement 100 has a wide variety of application. One of the many application areas is industrial applications which has high isolation requirement. In an embodiment, an integrated circuit (IC) with an antenna arrangement 100 is used for communication with an industrial mechanical device such as motor which is placed in a hostile environment. This communication is accomplished without the use of direct physical path. In such a case the IC with an antenna arrangement 100 utilizes magnetic coupling for establishing the communication. Also, the antenna arrangement 100 is used for transferring power from the industrial mechanical device to the IC without jeopardizing any isolation requirement. Thus the antenna arrangement 100 avoids the use of long running cables to provide power to the IC.

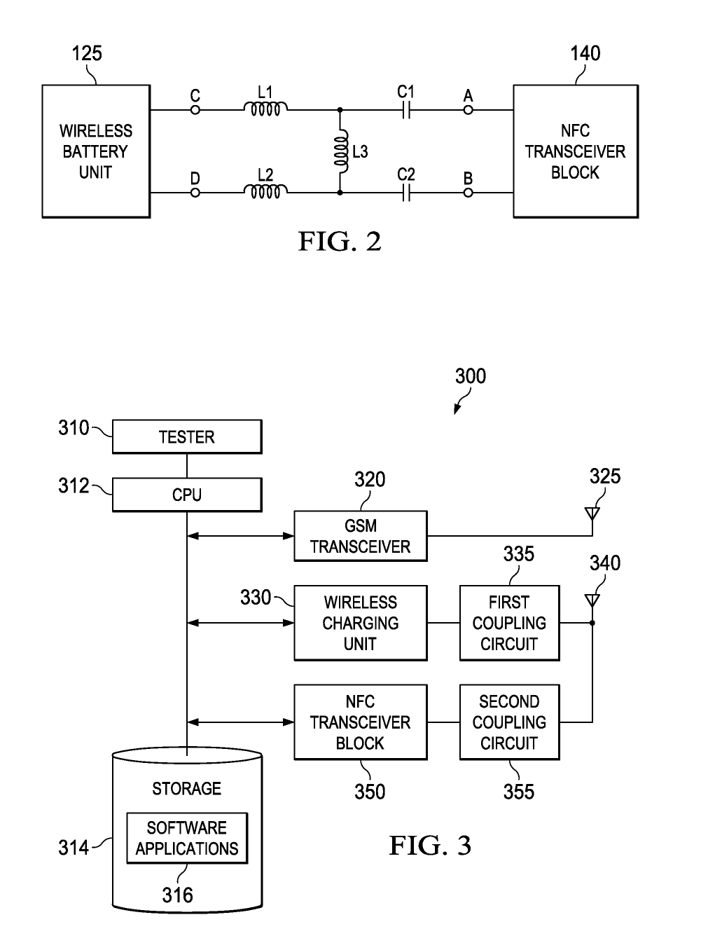

FIG. 2 illustrates a schematic of the inductance offered to the circuitry illustrated in FIG. 1, according to an embodiment. During wireless charging mode, the NFC transceiver block 140 is isolated i.e. the circuit is open-circuited at terminals A and B through capacitors C1 and C2. The wireless charging unit 125 operates at low frequencies and therefore, the capacitors C1 and C2 offer a large impedance to the wireless charging unit 125. This effectively isolates the NFC transceiver block 140 from the antenna arrangement 100. The effective inductance offered to the wireless charging unit 125 is sum of L1, L2 and L3, where L1 and L2 are a total inductance of the N1 turns in the outer antenna structure 105 and L3 is the a total inductance of the N2 turns in the inner antenna structure 110. The numerical value of L3 is less than L1 and L2. In one embodiment, magnitude of L1 and L2 are of the order of 10 uH while magnitude of L3 is of the order of 1 uH. During communication mode, the wireless charging unit 125 is isolated by the inductors L1 and L2. The inductors L1 and L2 offer a large impedance at NFC communication frequencies whereas the inductor L1 offers a very low impedance at the NFC communication frequencies. Thus, a current from NFC transceiver block 140 flows through the inductor L3 which offers a low impedance path and does not flow through the inductors L1 and L2 which offer a high impedance path. The effective inductance offered to the NFC transceiver block 140 is L3 which is within tuning range of the NFC transceiver block 140. Moreover, the capacitors C1 and C2 are also used to perform impedance matching between the antenna arrangement 100 and the NFC transceiver block 140.

FIG. 3 illustrates a computing device 300 according to an embodiment. The computing device 300 is, or is incorporated into, a mobile communication device, such as a mobile phone, a personal digital assistant, a personal computer, or any other type of electronic system.

In some embodiments, the computing device 300 comprises a megacell or a system-on-chip (SoC) which includes control logic such as a CPU 312 (Central Processing Unit), a storage 314 (e.g., random access memory (RAM)) and a tester 310. The CPU 312 can be, for example, a CISC-type (Complex Instruction Set Computer) CPU, RISC-type CPU (Reduced Instruction Set Computer), or a digital signal processor (DSP). The storage 314 (which can be memory such as RAM, flash memory, or disk storage) stores one or more software applications 316 (e.g., embedded applications) that, when executed by the CPU 312, perform any suitable function associated with the computing device 300. The tester 310 comprises logic that supports testing and debugging of the computing device 300 executing the software application 316. For example, the tester 310 can be used to emulate a defective or unavailable component(s) of the computing device 300 to allow verification of how the component(s), were it actually present on the computing device 300, would perform in various situations (e.g., how the component(s) would interact with the software application 316). In this way, the software application 316 can be debugged in an environment which resembles post-production operation.

The CPU 312 typically comprises memory and logic which store information frequently accessed from the storage 314. The computing device 300 includes a GSM (Global system for mobile communication) transceiver 320 and an antenna 325. The GSM transceiver transmits and receives GSM signals using antenna 325. In one embodiment, the computing device includes a CDMA (code-division multiple access) transceiver or other cellular transceiver. A wireless charging unit 330 is coupled to a first coupling circuit 335 which is coupled to antenna 340. An NFC transceiver block 350 is coupled to a second coupling circuit 355 which is coupled to antenna 340. Antenna 340 is used by both wireless charging unit 330 and NFC transceiver block 350 for transmission and reception of the corresponding signal types, and is therefore referred to as a single antenna. The antenna 340 is similar in connection and operation to antenna arrangement 100 illustrated in FIG. 1. The NFC transceiver block 350 transmits and receives NFC signals by inductive coupling via antenna 340. The second coupling circuit 355 provides impedance matching between the NFC transceiver block 350 and antenna 340. The first coupling circuit 335 also isolates the NFC signals from the wireless charging unit 330.

Wireless energy transmission techniques are based on inductive coupling between a transmit antenna embedded, for example, in a “charging” mat and a receive antenna (antenna 340) embedded in the computing device to be charged. A radiant field is received by antenna 340 and the energy is coupled to the first coupling circuit 335. In one embodiment, the first coupling circuit 335 includes a rectifier, a capacitor and an amplifier. The rectifier generates a DC signal from received signal and the capacitor temporarily stores the generated signal. The amplifier amplifies the stored signal. The amplified signal is stored in the wireless charging unit. The different components of the computing device 300 may be implemented on a same integrated circuit (IC) or on different ICs, or using discrete components. In one embodiment, the coupling circuits 335 and 355 are implemented using discrete components, or within an IC.

In the foregoing discussion, the terms “connected” means at least either a direct electrical connection between the devices connected or an indirect connection through one or more passive intermediary devices. The term “circuit” means at least either a single component or a multiplicity of passive components, that are connected together to provide a desired function. The term “signal” means at least one current, voltage, charge, data, or other signal. Also, the terms “coupled to” or “couples with” (and the like) are intended to describe either an indirect or direct electrical connection. Thus, if a first device is coupled to a second device, that connection can be through a direct electrical connection, or through an indirect electrical connection via other devices and connections. The term “on” applied to a transistor or group of transistors is generally intended to describe gate biasing to enable current flow through the transistor or transistors.

The foregoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims.

What is claimed is:

1. An antenna arrangement comprising:
an outer antenna structure in a form of a flat coil having N1 number of turns, wherein N1 is an integer;
an inner antenna structure in a form of a flat coil having N2 number of turns, wherein N2 is an integer; and
the outer antenna structure and the inner antenna structure are separated by a distance D.

2. The antenna arrangement of claim 1, wherein the inner antenna structure and the outer antenna structure are coplanar and the inner antenna structure is placed within the outer antenna structure.

3. The antenna arrangement of claim 1, wherein the N1 number of turns in the outer antenna structure is separated from each other by a distance d1 and the N2 number of turns in the inner antenna structure is separated from each other by a distance d2, wherein d1 and d2 are less than D.

4. The antenna arrangement of claim 1, wherein the outer antenna structure and the inner antenna structure combined is designed for charging a wireless charging unit.

5. The antenna arrangement of claim 1, wherein the inner antenna structure is designed to process a NFC (near field communication) signal received or transmitted by an NFC transceiver block.

6. The antenna arrangement of claim 1, wherein the outer antenna structure and the inner antenna structure are separated by a distance D to reduce a mutual coupling between the outer antenna structure and the inner antenna structure.

7. The antenna arrangement of claim 1 further comprising a first coupling circuit coupled to the outer antenna structure at a first port and a second coupling circuit coupled to the inner antenna structure at a second port.

8. The antenna arrangement of claim 7, wherein the first coupling circuit couples a wireless charging unit to the outer antenna structure and the second coupling circuit isolates the NFC transceiver block from the antenna arrangement during a time interval when the wireless charging unit is operational.

9. The antenna arrangement of claim 7, wherein the second coupling circuit couples the NFC transceiver block to the inner antenna structure.

10. A computing device comprising:
a wireless charging unit coupled to an antenna arrangement;
a NFC transceiver block coupled to the antenna arrangement; wherein the antenna arrangement comprises:
an outer antenna structure; and
an inner antenna structure coplanar with the outer antenna structure and placed within the outer antenna structure, wherein the outer antenna structure and the inner antenna structure are separated by a distance D to reduce an effective inductance offered to the NFC transceiver block.

11. The computing device of claim 10, wherein the outer antenna structure is in a form of a flat coil having N1 number of turns, wherein N1 is an integer, and the inner antenna structure is in a form of a flat coil having N2 number of turns, wherein N2 is an integer.

12. The computing device of claim 10, wherein the N1 number of turns in the outer antenna structure are separated from each other by a distance d2 and the N2 number of turns in the inner antenna structure are separated from each other by a distance d2, wherein d1 and d2 are less than D.

13. The computing device of claim 10, wherein the outer antenna structure and the inner antenna structure combined are designed for charging a wireless charging unit of the computing device and the inner antenna structure is designed to process a NFC (near field communication) signal received or transmitted by a NFC transceiver block of the computing device.

14. A method comprising:
coupling a first port of a single antenna to a first coupling circuit;
coupling a second port of the single antenna to a second coupling circuit;
coupling a wireless charging unit to the first coupling circuit;
coupling an NFC transceiver block to the second coupling circuit;
isolating the single antenna from the wireless charging unit during a time interval when the NFC transceiver block is operational; and
isolating the single antenna from the NFC transceiver block during a time interval when the wireless charging unit is operational.

15. The method of claim 14, wherein isolating the single antenna comprises:
forming N1 number of turns of a flat coil to design an outer antenna structure, wherein N1 is an integer;
forming N2 number of turns of a flat coil to design an inner antenna structure, wherein N2 is an integer and the inner antenna structure is coplanar with the outer antenna structure and placed within the outer antenna structure; and
separating the outer antenna structure and the inner antenna structure by a distance D to reduce the effective inductance offered to the NFC transceiver block.

16. The method of claim 14 further comprising configuring to combine the outer antenna structure and the inner antenna structure for charging the wireless charging unit, wherein the inner antenna structure is designed to process a NFC (near field communication) signal received or transmitted by the NFC transceiver block.

17. The method of claim 14, wherein the N1 number of turns in the outer antenna structure is separated from each other by a distance d1 and the N2 number of turns in the inner antenna structure is separated from each other by a distance d2, wherein d1 and d2 are less than D.
